(19) United States
(12) Patent Application Publication
(10) Pub. No.: US 2026/0353043 A1
(43) Pub. Date: Nov. 5, 2026

(54) POLICY CONTROL FUNCTION ENHANCEMENTS

(71) Applicant: T-Mobile USA, Inc., Bellevue, WA (US)

(72) Inventor: Suryaprakash Reddy Voodem, Bothell, WA (US)

(21) Appl. No.: 19/199,207

(22) Filed: May 5, 2025

(51) Int. Cl. H04W 4/24; H04L 12/14; H04W 8/20; H04W 76/19

(52) U.S. Cl. CPC H04W 4/24; H04L 12/1407; H04W 8/20; H04W 76/19

(57) ABSTRACT

Devices, systems, and methods to perform a policy control function (PCF) are disclosed. A device receives a first message including a usage counter status that is either throttled or capped, associated with a user from a charging control function (CHF). The device stores the usage counter status and sends a second message to a session management function (SMF). The second message instructs the SMF to reduce user data throughput when the usage counter status is throttled or block user data transfer when the usage counter status is capped, respectively. The device receives a third message from the CHF, in response to which it retains the stored policy counter status in its database and prevents sending of a fourth message to the SMF that instructs the SMF to provide unrestricted user data throughput or resume a user data transfer when the previously stored policy counter status is throttled or capped, respectively.

### BACKGROUND

Policy and charging control play an important role in a fifth generation (5G) wireless telecommunications network. They provide transparency and control over the consumption of network resources during real-time service delivery. A policy charging function (PCF) governs control plane functions of the wireless telecommunications network via policy rules that are defined by an operator of the wireless telecommunications network and user plane functions via enforcement of those policies. The PCF works closely with a charging function (CHF) for usage monitoring. Through the PCF, the operator can manage and govern network behavior. Key aspects of network performance management such as quality of service (QoS) control, traffic steering/routing, application and its capabilities detection, subscriber spending/usage monitoring, interworking with IP multimedia subsystem (IMS) nodes, enabling differentiated services, gating control, network slice enablement, roaming support, etc. are supported by the PCF.

The CHF is an integral entity in a converged charging system (CCS). It provides an account balance management function, a rating function, and a charging gateway function. Compared to an evolved packet core (EPC) of a fourth generation (4G) wireless telecommunications network, a CHF combines the functionality of an online charging function (OCF) and a charging data function (CDF). Thus, the CHF enables online and offline charging by closely interfacing with a session management function (SMF). CHF plays a critical role in monitoring the subscriber's usage and policy counters by interacting with the PCF. Together with the PCF, the CHF provides policy and charging control during service delivery.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flow diagram that illustrates aspects of conventional interoperation between a policy charging function (PCF), a charging function (CHF), and a session management function (SMF) in a wireless telecommunications network.

FIG. 4 is a flow diagram that illustrates the interoperation between a PCF, a CHF, and an SMF when aspects of the disclosed technology are implemented.

FIG. 5 is a flow diagram that illustrates aspects of conventional interoperation between a PCF, a CHF, and an SMF when a user qualifies to receive unrestricted service.

FIG. 6 is a flow diagram that illustrates interoperation between a PCF, a CHF, and an SMF when aspects of the disclosed technology are implemented and when a user qualifies to receive unrestricted service.

FIG. 7 is a flow diagram that illustrates aspects of conventional interoperation between a PCF, a CHF, and an SMF when a user qualifies to receive capped or throttled service.

FIG. 8 is a flow diagram that illustrates interoperation between a PCF, a CHF, and an SMF when aspects of the disclosed technology are implemented and when a user qualifies to receive capped or throttled service.

FIG. 9 is a flowchart of a process for implementing at least some aspects of the disclosed technology.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to technology to enhance the operation of a spending limit control service in a policy control function (PCF). In some embodiments, the charging function (CHF) periodically audits all subscriptions that the CHF has received from the PCF to identify whether the subscriptions are still valid by sending an N28 Notify message as defined in 3GPP Technical Specification 129.594 to the PCF. In some embodiments, the N28 Notify message can be empty, e.g., without any usage counters. In some embodiments, the empty N28 Notify message can further include a subscription permanent identifier (SUPI) associated with the user. When the subscription is invalid, for example, because a user associated with that subscription is no longer registered with the network, the PCF can indicate to the CHF that the subscription is invalid or not found. When a subscription is valid, for example, because a user associated with that subscription is still registered with the network, the PCF can send a message that includes the response code “204 No Content” to the CHF, confirming the validity of the subscription. In some embodiments, in addition to sending the “204 No Content” code to the CHF, the PCF can retain—instead of deleting—in its internal database, an old usage counter status that the PCF previously received from the CHF in association with the user. In some embodiments, in addition to retaining the old usage counter status, the PCF can prevent sending of a message, over an N7 interface between the PCF and a session management function (SMF) of the wireless telecommunications network, configured to restrict network performance for the user.

5G wireless networks use the N28 interface for interactions between the PCF and the CHF. The N28 interface facilitates communication between the PCF and CHF to ensure that network policy decisions are aligned with charging rules, which further ensure that users are charged accurately based on their usage with respect to network usage policies implemented by the network operator. This communication between the PCF and CHF is implemented using a subscription mechanism in which the PCF subscribes to receive notifications and updates from the CHF regarding charging events and related information. This subscription ensures that the PCF is kept informed about any changes or events that may impact policy enforcement and charging decisions. The communication between the CHF and PCF can include various usage counters that indicate, for example, whether a user qualifies to receive unrestricted service, whether the user's usage of the network exceeds a threshold, e.g., whether the user is in an overage state, whether the user's service is capped, e.g., subject to restricted data volume, whether the user's service is throttled, e.g., subject to restricted data throughput, etc. The N28 Notify message can include the user's SUPI, which is a unique identifier assigned to the user and is used by network functions such as the Authentication Server Function (AUSF) and the Unified Data Management (UDM) to manage subscriber information and services.

In a normal mode of operation of the wireless telecommunications network, the PCF can, in response to a usage counter status received from the CHF in a first N28 Notify message, evaluate or reevaluate a network performance policy to be applied to the user's data session in relation to the user's usage of the network. When the usage counter indicates that the user is in overage or is throttled or capped, the PCF can send a request to the SMF to restrict the network data volume or throughput that the user is allowed to receive. When the user's usage counter changes, the CHF sends a second N28 Notify message to the PCF indicating the counter change. However, when the second N28 Notify message does not contain any usage counters, such as when the CHF audits its subscriptions, the PCF can delete the old usage counter from its internal database, thereby revoking the network usage policy applied to the user session. This can result in the user being delivered better or worse network performance than what is applicable to that user based on their usage. For example, when the old usage counter status of throttled or capped is deleted by the PCF, the user can receive unrestricted data volume and throughput from the network despite not qualifying for such service levels.

Recognizing the above problem of incorrect service-level delivery, the inventor has proposed the novel enhancements disclosed herein to the behavior of the PCF that allow the CHF to periodically audit its subscriptions to delete stale entries while also preventing the PCF from directing the SMF to provide an incorrect service level to the user. When the technology disclosed herein is implemented in a wireless telecommunications network, user experience degradation and service revenue leakage can be prevented.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

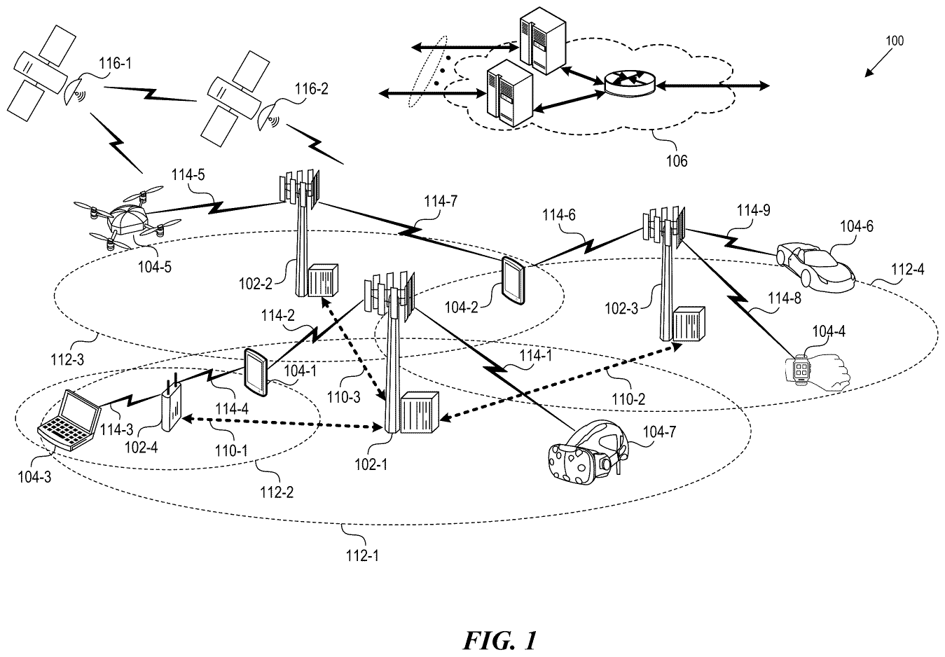

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally, or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

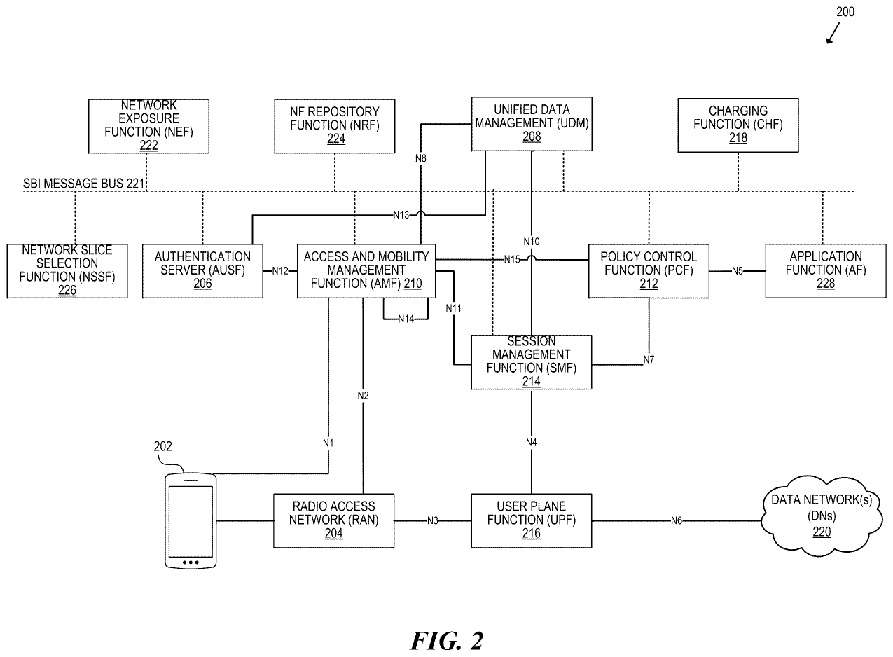

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Policy Control Function Enhancements

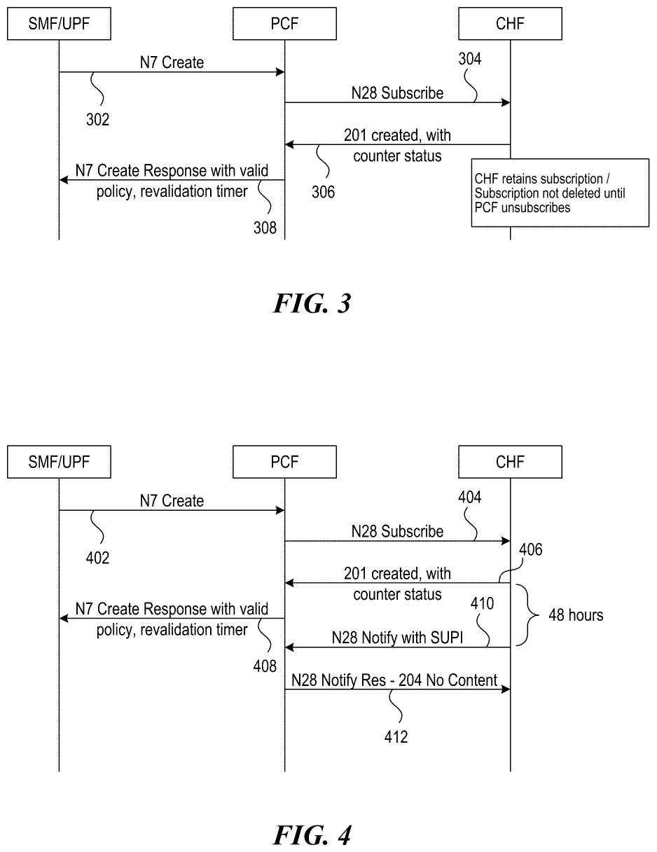

FIG. 3 is a flow diagram that illustrates aspects of conventional interoperation between a PCF, a CHF, and an SMF in a wireless telecommunications network. At 302, the PCF receives an N7 Create message over an N7 interface, which is a point-to-point interface between the PCF and the SMF, to initiate a new session associated with a user between the PCF and the SMF. Although FIGS. 3-8 show the SMF and UPF as a single entity, a person having ordinary skill in the art will recognize that whether the SMF and the UPF are combined into one entity or are separate entities is an implementation detail that may vary from one network equipment vendor to another network equipment vendor and from one wireless telecommunications network to another wireless telecommunications network.

At 304, in response to receiving the N7 Create message, the PCF sends an N28 Subscribe message to the CHF over an N28 interface, which is a point-to-point interface between the PCF and the CHF, to be notified about various charging events (e.g., the user's network usage exceeding a usage threshold, user session start, user session end, etc.).

At 306, the CHF responds to the PCF with a 201 Created message, indicating that the subscription to charging events was successfully created. The CHF includes a current usage counter status associated with the user. The usage counter status can be, for example, active if the user's network usage does not exceed a first network usage policy threshold, and resultantly, the user qualifies to receive unrestricted service from the wireless telecommunications network. The usage counter status can be, for example, overage if the user's network usage exceeds a second network usage policy threshold. The usage counter status can be, for example, throttled if the user's network usage exceeds a third network usage policy threshold, and resultantly, the user qualifies to receive throttled, e.g., lowered, network speed. The usage counter status can be, for example, capped if the user's network usage exceeds a fourth network usage policy threshold, and resultantly, the user does not qualify to receive service. Once a subscription associated with a user is created, the CHF can retain that subscription in its internal database until the PCF sends another message to the CHF to cancel the subscription. When the PCF sends an unsubscribe message to the CHF, the CHF can delete the subscription from its internal database. At 308, the PCF sends an N7 Create Response back to the SMF to confirm that the new session associated with the user has been created. The N7 Create Response includes a network performance policy to be applied to the user's session and a revalidation timer indicating to the SMF for how long the session or the network performance policy is valid before requiring revalidation.

FIG. 4 is a flow diagram that illustrates the interoperation between a PCF, a CHF, and an SMF when aspects of the disclosed technology are implemented. Operations 402, 404, 406, and 408 of FIG. 4 are analogous to operations 302, 304, 306, and 308, respectively, of FIG. 3. In some embodiments of the disclosed technology, at 410, the CHF can periodically initiate an audit of the user subscription to identify whether the subscription is still valid—for example, whether the user associated with each subscription is still registered with the wireless telecommunications network. While FIG. 4 shows the CHF initiating the audit 48 hours after operation 406 in which the subscription was created, a person having ordinary skill in the art will recognize that the periodicity can be less or more than 48 hours as per the preference of an operator of the wireless telecommunications network. To initiate the audit, the CHF can send an N28 Notify message to the PCF. In some embodiments, the N28 message can include a subscription permanent identifier (SUPI), which is a unique identifier assigned to the user. At 412, in response to receiving the audit request from the CHF in the form of an N28 Notify message, the PCF can send an N28 Notify response message to the CHF. In some embodiments, the N28 Notify response can include a response code 204 No Content, which indicates to the CHF that the subscription is still valid—for example, when the user associated with the subscription is still registered with the wireless telecommunications network.

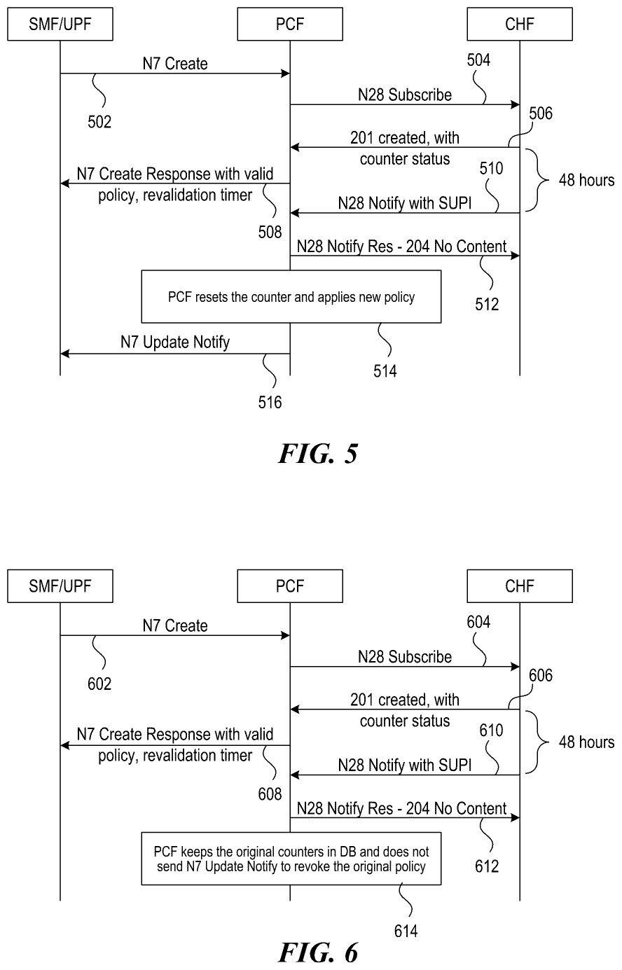

FIG. 5 is a flow diagram that illustrates aspects of conventional interoperation between a PCF, a CHF, and an SMF when a user qualifies to receive unrestricted service. Operations 502 and 504 of FIG. 5 are analogous to operations 302 and 304, respectively, of FIG. 3. At 506, the CHF responds to the PCF with a 201 Created message, indicating that the subscription to charging events was successfully created. The CHF includes a current usage counter status associated with the user. When the user's network usage does not exceed a first network usage policy threshold and, resultantly, the user qualifies to receive unrestricted service from the wireless telecommunications network, the current usage counter status is active. Operation 508 of FIG. 5 is analogous to operation 308 of FIG. 3. Thus, at 508, the PCF sends an N7 Create Response back to the SMF to confirm that the new session associated with the user has been created. The N7 Create Response includes a network performance policy corresponding to the user's current usage counter of active. This network performance policy is to be applied by the SMF to the user's session. The N7 Create Response can include a revalidation timer indicating to the SMF for how long the session or the network performance policy is valid before requiring revalidation.

Operations 510 and 512 of FIG. 5 are analogous to operations 410 and 412 of FIG. 4. Thus, in some embodiments, at 510, the CHF can periodically initiate an audit to identify whether the subscription is still valid by sending to the PCF an N28 Notify message that includes the user's SUPI. At 512, in response to receiving the audit request from the CHF, the PCF can send an N28 Notify response that includes a response code 204 No Content, indicating to the CHF that the subscription is still valid. At 514, the PCF resets the usage counter status in its internal database and applies a network performance policy associated with the usage counter status of active to the user session. At 516, the PCF sends an N7 Update Notify message to the SMF, indicating to the SMF to allow unrestricted service to the user and setting a new status for the revalidation timer for the user session.

FIG. 6 is a flow diagram that illustrates interoperation between a PCF, a CHF, and an SMF when aspects of the disclosed technology are implemented and when a user qualifies to receive unrestricted service. Operations 602, 604, 606, 608, 610, and 612 are analogous to operations 502, 504, 506, 508, 510, and 512 of FIG. 5. Thus, in response to receiving a 201 Created message from the CHF in operation 606, the PCF sends an N7 Create Response to the SMF, along with a network performance policy to be applied to the user session, and a revalidation timer for which the policy is to be applied. At 610, the PCF can receive an empty N28 Notify message, e.g., one containing no usage counter, that includes a SUPI associated with the user. In some embodiments, this N28 Notify message can be part of the CHF's audit. At 612, the PCF can respond to the CHF with an N28 Notify response message that contains a response code 204 No Content, indicating to the CHF that the user session is valid. In some embodiments when the disclosed technology is implemented, at 614, the PCF can prevent resetting of the usage counter in its internal database. In some embodiments when the disclosed technology is implemented, the PCF can further prevent sending of an N7 Update Notify message to the SMF to revoke a current network performance policy applied to the user session. Thus, the PCF's message processing and database update load and network signaling traffic between the PCF and the SMF are reduced.

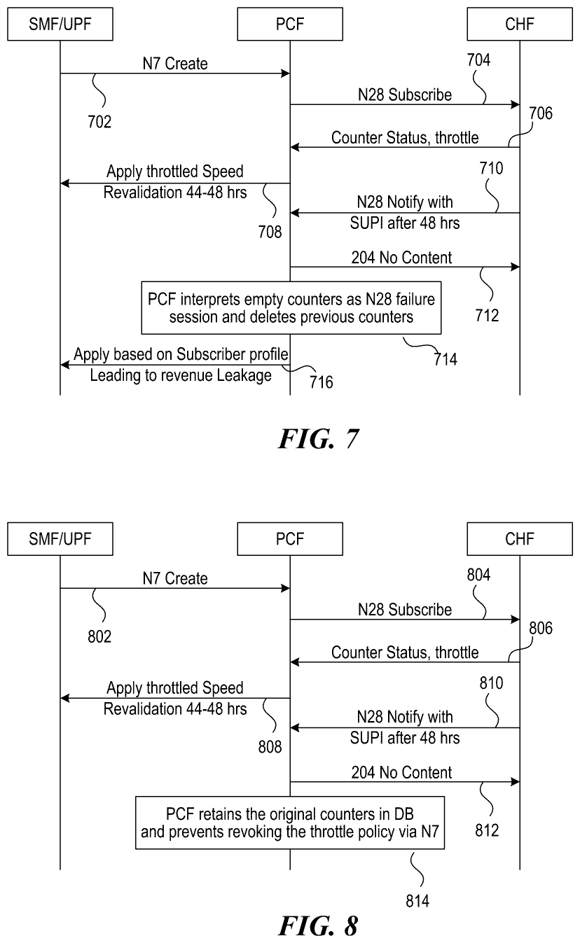

FIG. 7 is a flow diagram that illustrates aspects of conventional interoperation between a PCF, a CHF, and an SMF when a user qualifies to receive capped or throttled service. Operations 702 and 704 are analogous to operations 302 and 304 of FIG. 3. At 706, the CHF responds to the PCF with a 201 Created message, indicating that the subscription to charging events was successfully created. The CHF includes a current usage counter status associated with the user. The current usage counter status can be, for example, throttled when the user's network usage exceeds the third network usage policy threshold, and resultantly, the user qualifies to receive throttled, e.g., lowered, network speed. The usage counter status can be, for example, capped when the user's network usage exceeds a fourth network usage policy threshold, and resultantly, the user does not qualify to receive service.

Operation 708 of FIG. 7 is analogous to operation 308 of FIG. 3. Thus, at 708, the PCF sends an N7 Create Response back to the SMF to confirm that the new session associated with the user has been created. The N7 Create Response includes a network performance policy corresponding to the user's current usage counter of throttled or capped that is to be applied by the SMF to the user's session. The N7 Create Response can include a revalidation timer indicating to the SMF for how long the session or the network performance policy is valid before requiring revalidation. At 710, the PCF can receive an empty N28 Notify message, e.g., one containing no usage counter, that includes a SUPI associated with the user. In some embodiments, this N28 Notify message can be part of the CHF's audit. At 712, the PCF can respond to the CHF with an N28 Notify response message that contains a response code 204 No Content, indicating to the CHF that the user session is valid. At 714, the PCF interprets the missing usage counter in the N28 Notify message at operation 710 as a messaging failure and deletes, from the PCF's internal database, the usage counter previously received from the CHF in operation 706. At 716, the PCF sends an N7 Notify message to the SMF indicating to the SMF to apply a default network performance policy to the user session that is based on a subscriber profile of the user. Despite the user's subscriber profile allowing unrestricted service to the user, for example, based on the price plan that the user subscribes to, based on the user's actual network usage, the user may not qualify to receive unrestricted service. However, due to the PCF deleting the throttled or capped usage counter from its internal database in operation 714, the user may receive unrestricted service instead of receiving speed-restricted (e.g., throttled) or volume-restricted (e.g., capped) service, resulting in revenue leakage for the operator of the wireless telecommunications network.

FIG. 8 is a flow diagram that illustrates interoperation between a PCF, a CHF, and an SMF when aspects of the disclosed technology are implemented and when a user qualifies to receive capped or throttled service. Operations 802, 804, 806, and 808 of FIG. 8 are analogous to operations 702, 704, 706, and 708 of FIG. 7. Thus, at operation 806, the PCF can receive an N28 Notify message with a usage counter status of throttled or capped from the CHF. At 808, the PCF can send an N7 Create Response back to the SMF to confirm that the new session associated with the user has been created. The N7 Create Response can include a network performance policy corresponding to the user's current usage counter of throttled or capped that is to be applied by the SMF to the user's session. The N7 Create Response can include a revalidation timer indicating to the SMF for how long the session or the network performance policy is valid before requiring revalidation. At 810, the PCF can receive an empty N28 Notify message, e.g., one containing no usage counter, that includes a SUPI associated with the user. In some embodiments, this N28 Notify message can be part of the CHF's audit. At 812, the PCF can respond to the CHF with an N28 Notify response message that contains a response code 204 No Content, indicating to the CHF that the user session is valid. In some embodiments of the disclosed technology, at 814, instead of deleting the old usage counter status from its internal database in response to receiving empty usage counters from the CHF in operation 810, the PCF can retain the old usage counter. In some embodiments, the PCF can further prevent sending an N7 Update Notify message to the SMF to revoke the throttled or capped network performance policy applied to the user session based on the previous usage counter status received in operation 806. Thus, when the disclosed technology is implemented, the CHF can perform an audit of the user subscription without triggering the PCF to revoke an existing network performance policy applied to the user session.

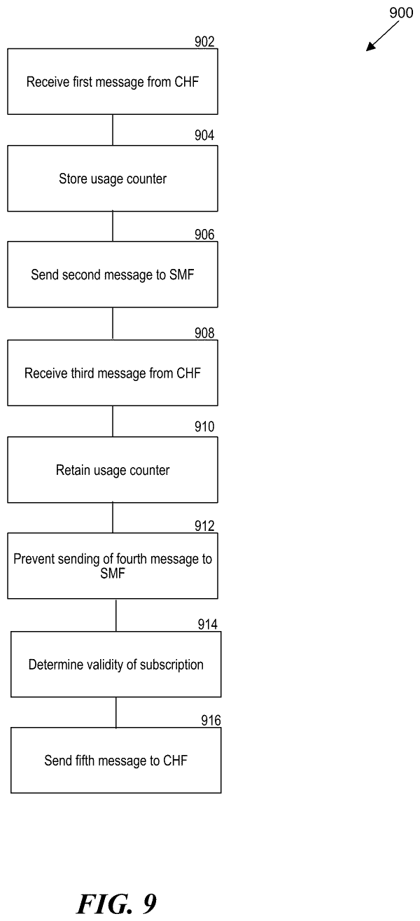

FIG. 9 is a flowchart of a process 900 for implementing at least some aspects of the disclosed technology. The process 900 can be implemented in a device configured to perform a policy control function (PCF) in a wireless telecommunications network. At 902, the device receives a first message including a usage counter status associated with a user session from a charging control function (CHF) of the wireless telecommunications network. In some embodiments, the usage counter status can be one of throttled or capped. At 904, the device stores the usage counter status in a database of the device. At 906, the device sends a second message to a session management function (SMF) of the wireless telecommunications network. In some embodiments, the device can send the second message to the SMF over a point-to-point interface between the device and the SMF. In some embodiments, when the usage counter status is throttled, the second message instructs the SMF to reduce a data throughput of the user session below a first threshold. In some embodiments, when the usage counter status is capped, the second message instructs the SMF to block a data transfer of the user session. At 908, the device receives a third message associated with the user session from the CHF. In some embodiments, the third message does not include a usage counter status. In some embodiments, the third message includes a subscription permanent identifier (SUPI) associated with the user. In some embodiments, the device can receive the first message and the third message from the CHF over a point-to-point interface between the device and the CHF.

At 910, in response to receiving the third message, the device retains the stored policy counter status in the database of the device. At 912, in response to receiving the third message, the device further prevents sending of a fourth message to the SMF. In some embodiments, when the previously stored policy counter status is throttled, the fourth message instructs the SMF to provide unrestricted data throughput to the user session. In some embodiments, when the previously stored policy counter status is capped, the fourth message instructs the SMF to resume a data transfer of the user session. In some embodiments, the device can prevent sending of the fourth message to the SMF over a point-to-point interface between the device and the SMF.

In some embodiments, at 914, in response to receiving the third message associated with the user session from the CHF, the device further determines a validity status of a spending limit reporting subscription of the device with the CHF. The spending limit reporting subscription can be associated with the user session. In some embodiments, at 916, in response to determining that the validity status of the spending limit reporting subscription is valid, the device can send a fifth message to the CHF, which includes a response code indicating no content.

### Computer System

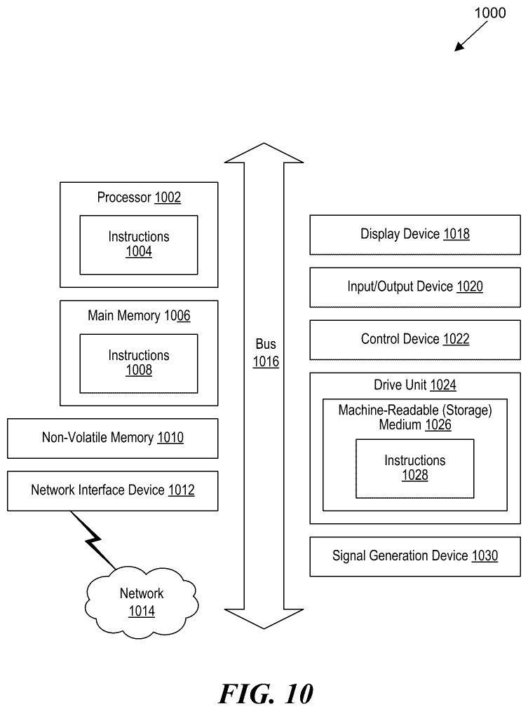

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having operations, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A device configured to perform a policy control function (PCF) in a wireless telecommunications network, the device comprising:
at least one hardware processor; and
at least one non-transitory memory storing instructions, which, when executed by the at least one hardware processor, cause the device to:
receive a first message including a usage counter status associated with a user session from a charging control function (CHF) of the wireless telecommunications network,
wherein the usage counter status is one of throttled or capped;
store the usage counter status in a database of the device;
send a second message to a session management function (SMF) of the wireless telecommunications network,
wherein when the usage counter status is throttled, the second message instructs the SMF to reduce a data throughput of the user session below a first threshold, and
wherein when the usage counter status is capped, the second message instructs the SMF to block a data transfer of the user session;
receive a third message associated with the user session from the CHF; and
in response to receiving the third message:
retain the stored usage counter status in the database of the device; and
prevent sending of a fourth message to the SMF,
wherein when the previously stored policy counter status is throttled, the fourth message instructs the SMF to provide unrestricted data throughput to the user session, and
wherein when the previously stored policy counter status is capped, the fourth message instructs the SMF to resume a data transfer of the user session.

2. The device of claim 1, wherein the third message does not include a usage counter status.

3. The device of claim 2, wherein the third message includes a subscription permanent identifier (SUPI) associated with the user.

4. The device of claim 3 further caused to, in response to receiving the third message associated with the user session from the CHF:
determine a validity status of a spending limit reporting subscription of the device with the CHF,
wherein the spending limit reporting subscription is associated with the user session; and
in response to determining that the validity status of the spending limit reporting subscription is valid, sending a fifth message to the CHF,
wherein the fifth message includes a response code indicating no content.

5. The device of claim 1 caused to:
receive the first message and the third message from the CHF over a point-to-point interface between the device and the CHF.

6. The device of claim 1 caused to:
send the second message to the SMF over a point-to-point interface between the device and the SMF.

7. The device of claim 1 caused to:
prevent sending of the fourth message to the SMF over a point-to-point interface between the device and the SMF.

8. A system comprising:
at least one hardware processor; and
at least one non-transitory memory storing instructions, which, when executed by the at least one hardware processor, cause the system to:
receive, at a policy control function (PCF) of a wireless telecommunications network, a first message including a usage counter status associated with a user session from a charging control function (CHF) of the wireless telecommunications network,
wherein the usage counter status is one of throttled or capped;
store the usage counter status in a database of the PCF;
send, from the PCF, a second message to a session management function (SMF) of the wireless telecommunications network,
wherein when the usage counter status is throttled, the second message instructs the SMF to reduce a data throughput of the user session below a first threshold, and
wherein when the usage counter status is capped, the second message instructs the SMF to block a data transfer of the user session;
receive, at the PCF, a third message associated with the user session from the CHF; and
in response to receiving the third message:
retain the stored usage counter status in the database of the PCF; and
prevent sending of a fourth message from the PCF to the SMF,
wherein when the previously stored policy counter status is throttled, the fourth message instructs the SMF to provide unrestricted data throughput to the user session, and
wherein when the previously stored policy counter status is capped, the fourth message instructs the SMF to resume a data transfer of the user session.

9. The system of claim 8, wherein the third message does not include a usage counter status.

10. The system of claim 9, wherein the third message includes a subscription permanent identifier (SUPI) associated with the user.

11. The system of claim 10 further caused to, in response to the PCF receiving the third message associated with the user session from the CHF:
determine, by the PCF, a validity status of a spending limit reporting subscription of the PCF with the CHF,
wherein the spending limit reporting subscription is associated with the user session; and
in response to the PCF determining that the validity status of the spending limit reporting subscription is valid, sending, from the PCF, a fifth message to the CHF,
wherein the fifth message includes a response code indicating no content.

12. The system of claim 8 caused to:
receive, at the PCF, the first message and the third message from the CHF over a point-to-point interface between the PCF and the CHF.

13. The system of claim 8 caused to:
send, from the PCF, the second message to the SMF over a point-to-point interface between the PCF and the SMF.

14. The system of claim 8 caused to:
prevent sending of the fourth message from the PCF to the SMF over a point-to-point interface between the PCF and the SMF.

15. A method comprising:
receiving, at a policy control function (PCF) of a wireless telecommunications network, a first message including a usage counter status associated with a user session from a charging control function (CHF) of the wireless telecommunications network,
wherein the usage counter status is one of throttled or capped;
storing the usage counter status in a database of the PCF;
sending, from the PCF, a second message to a session management function (SMF) of the wireless telecommunications network,
wherein when the usage counter status is throttled, the second message instructs the SMF to reduce a data throughput of the user session below a first threshold, and
wherein when the usage counter status is capped, the second message instructs the SMF to block a data transfer of the user session;
receiving, at the PCF, a third message associated with the user session from the CHF;
in response to receiving the third message:
retaining the stored usage counter status in the database of the PCF; and
preventing sending of a fourth message from the PCF to the SMF,
wherein when the previously stored policy counter status is throttled, the fourth message instructs the SMF to provide unrestricted data throughput to the user session, and
wherein when the previously stored policy counter status is capped, the fourth message instructs the SMF to resume a data transfer of the user session.

16. The method of claim 15,
wherein the third message includes a subscription permanent identifier (SUPI) associated with the user, and
wherein the third message does not include a usage counter status.

17. The method of claim 16 further comprising, in response to the PCF receiving the third message associated with the user session from the CHF:
determining, by the PCF, a validity status of a spending limit reporting subscription of the PCF with the CHF,
wherein the spending limit reporting subscription is associated with the user session; and
in response to the PCF determining that the validity status of the spending limit reporting subscription is valid, sending, from the PCF, a fifth message to the CHF,
wherein the fifth message includes a response code indicating no content.

18. The method of claim 15,
wherein the first message and the third message are received at the PCF from the CHF over a point-to-point interface between the PCF and the CHF.

19. The method of claim 15,
wherein the second message is sent from the PCF to the SMF over a point-to-point interface between the PCF and the SMF.

20. The method of claim 15,
wherein the PCF is prevented from sending the fourth message to the SMF over a point-to-point interface between the PCF and the SMF.
